(19) United States
(12) Patent Application Publication
(10) Pub. No.: US 2023/0305917 A1
(43) Pub. Date: Sep. 28, 2023

(54) OPERATION MANAGEMENT APPARATUS AND METHOD

(71) Applicant: Hitachi, Ltd., Tokyo (JP)

(72) Inventors: Rong ZHANG, Tokyo (JP); Hiroshi HAYAKAWA, Tokyo (JP); Yuusuke TAKADA, Tokyo (JP); Takeshi ARISAKA, Tokyo (JP); Yasuto NISHII, Tokyo (JP)

(73) Assignee: Hitachi, Ltd., Tokyo (JP)

(21) Appl. No.: 17/903,483

(22) Filed: Sep. 6, 2022

(30) Foreign Application Priority Data
Feb. 4, 2022 (JP) 2022-016028

(51) Int. Cl. G06F 11/07; G06Q 30/02

(52) U.S. Cl. CPC G06F 11/0793; G06F 11/0721; G06Q 30/0283

(57) ABSTRACT

There are proposed a highly reliable operation management apparatus and method capable of presenting highly effective countermeasures. An operation management apparatus for managing operation of an entire system including one or a plurality of management target apparatuses, and an operation management method executed by the operation management apparatus are designed to: extract, from logs, content of a series of configuration changes performed with respect to a management target apparatus during a period of time after an anomaly of the management target apparatus was detected until the anomaly was solved, and record the extracted content of the series of configuration changes as a configuration change history; generate anomaly handling rules by generalizing the content of the recorded configuration change history; and, when detecting an anomaly, generate one or a plurality of proposed countermeasures by using the anomaly handling rules, which are applicable, and present the generated proposed countermeasure(s) to a user.

### TECHNICAL FIELD

The present invention relates to an operation management apparatus and method and is suited for application to the operation management apparatus which manages the operation of one or a plurality of apparatuses.

### BACKGROUND ART

Conventionally, there have been management apparatuses designed to be capable of presenting an anomaly handling method when they detect an anomaly of a management target system or apparatus. As an example of such a management apparatus, PTL 1 discloses that: a technique for analyzing a root cause is utilized upon the occurrence of a problem; developed rules are created by developing general rules, which specify a method for handling various kinds of anomalies, to a handling method applied to target equipment; and a plurality of proposed countermeasures are proposed by predicting the effects of the handling method based on the created developed rules.

However, according to the technique disclosed in this PTL 1, there is a problem such that proposed countermeasures which can be presented by the management apparatus are fixed only to proposed countermeasures against failures specified in the general rules and the developed rules and a new proposed countermeasure(s) cannot be added during the operation of the management apparatus.

Regarding the above-described problem, PTL 2 discloses, regarding a management apparatus, that: handling rules are narrowed down on the basis of a label indicating the relationship with a combination of anomaly detection rules and the handling rules and a computer system; a simulation is executed when the narrowed-down handling rules are applied to the computer system; and the handling rules are decided on the basis of the simulation results. Such a method makes it possible to dynamically propose a proposed countermeasure(s) against an anomaly which has occurred during the operation.

### CITATION LIST

### Patent Literature

PTL 1: U.S. Unexamined Pat. Application Publication No. 2014/0068343
PTL 2: Japanese Patent Application No. 2020-175340

### SUMMARY OF THE INVENTION

### Problems to Be Solved by the Invention

However, with the above-mentioned simulation executed by the technique disclosed in PTL 2, it is difficult to predict all actual changes when applying the handling rules to actual apparatuses. So, there is a problem of difficulty in checking the effectiveness of the handling rules against an actual apparatus anomaly/anomalies when the handling rules are applied to the computer system.

The present invention was devised in consideration of the above-described circumstances and aims at proposing a highly reliable operation management apparatus and method capable of presenting highly effective countermeasures.

### Means to Solve the Problems

In order to solve the above-described problems, there is provided according to the present invention an operation management apparatus for managing operation of an entire system including one or a plurality of management target apparatuses, wherein the operation management apparatus includes: an anomaly detection unit that detects an anomaly of the management target apparatus; a configuration change extraction unit that extracts, from logs, content of a series of configuration changes performed with respect to the management target apparatus during a period of time after the anomaly detection unit detected the anomaly of the management target apparatus until the anomaly was solved, and records the content of the series of configuration changes as a configuration change history; an anomaly handling rule generation unit that generates anomaly handling rules by generalizing the content of the configuration change history recorded by the configuration change extraction unit; and a proposed countermeasure presentation unit that, when the anomaly detection unit detects a new anomaly, generates one or a plurality of proposed countermeasures by using the anomaly handling rules, which are applicable, and presents the generated proposed countermeasure to a user.

Furthermore, there is provided according to the present invention an operation management method executed by an operation management apparatus for managing operation of an entire system including one or a plurality of management target apparatuses, wherein the operation management method includes: a first step of extracting, from logs, content of a series of configuration changes performed with respect to the management target apparatus during a period of time after the anomaly of the management target apparatus was detected until the anomaly was solved, and recording the extracted content of the series of configuration changes as a configuration change history; a second step of generating anomaly handling rules by generalizing the content of the recorded configuration change history; and a third step, which is executed when detecting an anomaly, of generating one or a plurality of proposed countermeasures by using the anomaly handling rules, which are applicable, and presenting the generated proposed countermeasure to a user.

The operation management apparatus and method according to the present invention make it possible to generate and present the proposed countermeasure(s) against the latest anomaly on the basis of a series of configuration changes which were made upon the occurrence of anomalies in the past and by which the anomalies were solved.

### Advantageous Effects of the Invention

The highly reliable operation management apparatus and method capable of presenting highly effective countermeasures can be realized according to the present invention.

### BRIEF DESCRIPTION OF DRAWINGS

FIG. 1 is a block diagram illustrating an overall configuration of a computer system according to this embodiment;

FIG. 2 is a block diagram illustrating an overall configuration of an operation management apparatus;

FIG. 3 is a chart illustrating a configuration example of a management target management table;

FIG. 4 is a chart illustrating a configuration example of an intra-organization management apparatus management table;

FIG. 5 is a chart illustrating a configuration example of an apparatus configuration management table;

FIG. 6 is a chart illustrating a configuration example of an operating information management table;

FIG. 7 is a chart illustrating a configuration example of a log management table;

FIG. 8 is a chart illustrating a configuration example of an anomaly judgment rule management table;

FIG. 9 is a chart illustrating a configuration example of a configuration change history management table;

FIG. 10 is a chart illustrating a configuration example of an anomaly handling rule management table;

FIG. 11 is a chart illustrating a configuration example of a configuration change operation management table;

FIG. 12 is a chart illustrating a configuration example of a configuration change cost management table;

FIG. 13 is a chart illustrating a configuration example of a proposed countermeasure evaluation function management table;

FIG. 14 is a flowchart illustrating a processing sequence for anomaly handling and anomaly handling rule generation processing;

FIG. 15 is a flowchart illustrating a processing sequence for apparatus information collection processing;

FIG. 16 is a flowchart illustrating a processing sequence for anomaly detection processing;

FIG. 17 is a flowchart illustrating a processing sequence for anomaly handling rule generation processing;

FIG. 18 is a flowchart illustrating a processing sequence for anomaly handling processing;

FIG. 19A and FIG. 19B are a diagram and chart, respectively, for explaining a candidate proposed countermeasure generation method;

FIG. 20 is a chart illustrating a detailed example of three generated candidate proposed countermeasures;

FIG. 21 is a chart illustrating an example of an anomaly improvement indexation value, a required amount-of-time indexation value, and a change cost indexation value of the three generated candidate proposed countermeasures; and

FIG. 22 is a flowchart illustrating a processing sequence for configuration change processing.

### DESCRIPTION OF EMBODIMENTS

An embodiment of the present invention will be described below in detail with reference to the drawings.

### Configuration of Computer System According to This Embodiment

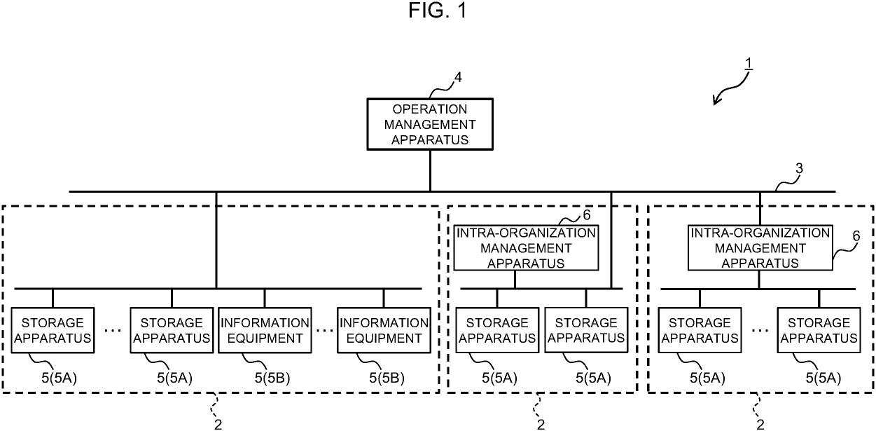

Referring to FIG. 1, the reference numeral 1 represents a computer system according to this embodiment as a whole. This computer system 1 is configured by including a plurality of organizations 2 and an operation management apparatus 4 which is connected with these organizations 2, respectively, via a network 3.

Each organization 2 is a collective entity of one or a plurality of storage apparatuses 5A, which are management targets respectively installed, for example, within a company or at a data center, or is a collective entity of one or a plurality of storage apparatuses 5A and one or a plurality of pieces of information equipment 5B which are management targets. The information equipment 5B is configured from, for example, a server apparatus, switch equipment, or IoT (Internet of Things) equipment. Incidentally, the storage apparatus(es) 5A and the information equipment 5B which are the management targets will be hereinafter collectively referred to as a “management target apparatus(es) 5.”

Moreover, each of some organizations 2 is provided with an intra-organization management apparatus 6 for managing the management target apparatuses 5 which belong to the organization 2. Practically, the intra-organization management apparatus 6 performs management work to, for example, regularly collect configuration information and operating information of each management target apparatus 5 in the organization 2, to which the intra-organization management apparatus 6 belongs, create a volume within a management target apparatus 5 designated according to an instruction from the operation management apparatus 4, or delete a volume within the designated management target apparatus 5.

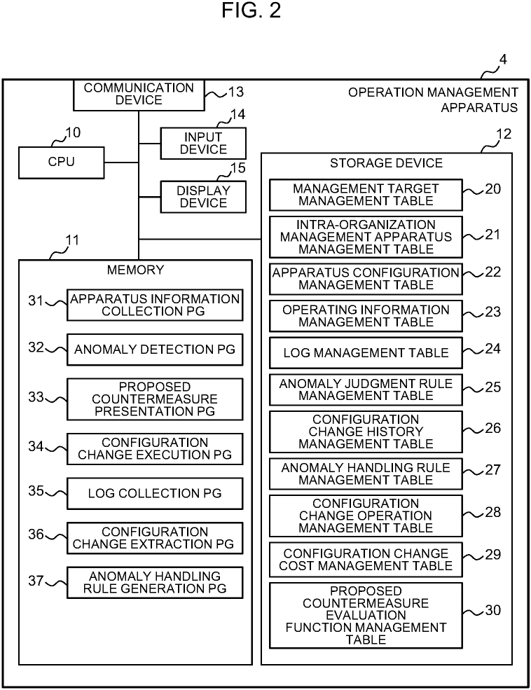

The operation management apparatus 4 is a computer apparatus for managing the operation of the entire computer system 1 and is configured by including, as illustrated in FIG. 2, a CPU (Central Processing Unit) 10, a memory 11, a storage device 12, a communication device 13, an input device 14, and a display device 15.

The CPU 10 is a processor which controls actions of the entire operation management apparatus 4. Moreover, the memory 11 is configured from, for example, a volatile semiconductor memory and is used as a work memory for the CPU 10. Furthermore, the storage device 12 is configured from a nonvolatile, large-capacity storage device such as a hard disk drive or an SSD (Solid State Drive) and stores various kinds of programs and various kinds of data which need to be saved for a long period of time.

Necessary programs are read from the storage device 12 to the memory 11 when activating the operation management apparatus 4 or whenever necessary and the CPU 10 executes the programs which have been read to the memory 11, thereby executing various kinds of processing of the operation management apparatus 4 as a whole as described later.

The communication device 13 is configured from, for example, an NIC (Network Interface Card) and performs protocol control when the operation management apparatus 4 communicates with, for example, other apparatuses within the computer system 1 via the network 3 (FIG. 1).

The input device 14 is configured from, for example, a keyboard and a mouse and is used when the user inputs necessary information and instructions to the operation management apparatus 4. Moreover, the display device 15 is configured from, for example, a liquid crystal display or an organic EL (Electro Luminescence) display and is used to display necessary screens and information. Incidentally, a touch panel in which the input device 14 and the display device 15 are integrated together may also be applied.

### Proposed Countermeasure Presentation and Execution Function Upon Anomaly

Next, an explanation will be provided about a proposed countermeasure presentation and execution function upon anomaly, which is mounted in the operation management apparatus 4 according to this embodiment. This proposed countermeasure presentation and execution function upon anomaly is a function that: records the content of countermeasures performed with respect to a management target apparatus 5 during a period of time after an anomaly of the management target apparatus 5 was detected until the anomaly was solved (a series of configuration changes), as a configuration change history; generates anomaly handling rules by generalizing the content of the countermeasures which were then executed (a series of configuration changes), on the basis of the recorded configuration change history; and, if a new anomaly subsequently occurs, generates one or a plurality of candidates for proposed countermeasures (hereinafter referred to as “candidate proposed countermeasures”) by using the anomaly handling rules which are applicable, presents the candidate proposed countermeasures to a user, and executes a candidate proposed countermeasure selected by the user from among the presented candidate proposed countermeasures.

As means for implementing the above-described proposed countermeasure presentation and execution function upon anomaly, the storage device 12 for the operation management apparatus 4 stores a management target management table 20, an intra-organization management apparatus management table 21, an apparatus configuration management table 22, an operating information management table 23, a log management table 24, an anomaly judgment rule management table 25, a configuration change history management table 26, an anomaly handling rule management table 27, a configuration change operation management table 28, a configuration change cost management table 29, and a proposed countermeasure evaluation function management table 30. Moreover, the memory 11 for the operation management apparatus 4 stores an apparatus information collection program 31, an anomaly detection program 32, a proposed countermeasure presentation program 33, a configuration change extraction program 36, an anomaly handling rule generation program 37, a configuration change execution program 34, and a log collection program 35.

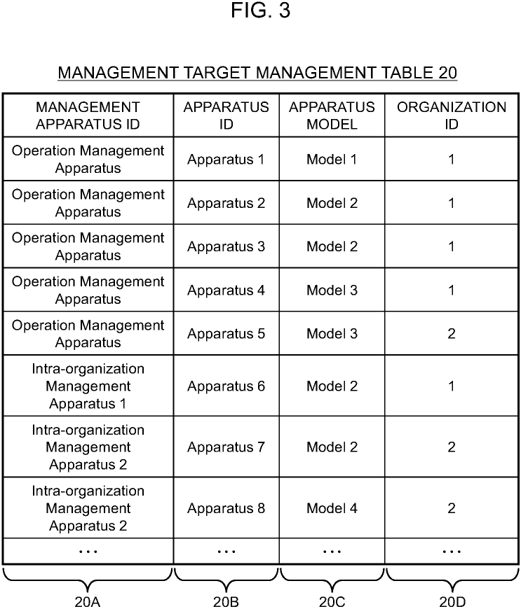

The management target management table 20: is a table in which all the management target apparatuses 5 within the computer system 1 managed by the operation management apparatus 4 or the intra-organization management apparatus 6 of each organization 2 are registered; and is configured by including, as illustrated in FIG. 3, a management apparatus ID column 20A, an apparatus ID column 20B, an apparatus model column 20C, and an organization ID column 20D. In the management target management table 20, one record (row) corresponds to one management target apparatus 5.

Then, the apparatus ID column 20B stores a unique identifier of the relevant management target apparatus 5 (an apparatus ID), which is assigned to the relevant management target apparatus 5; and the apparatus model column 20C stores a model name of that management target apparatus 5. Furthermore, the organization ID column 20D stores an identifier of an organization 2 to which the relevant management target apparatus 5 belongs (an organization ID); the management system ID column 20A stores an identifier of an operation management apparatus 4 or an intra-organization management apparatus 6 which manages the relevant management target apparatus 5 (a management apparatus ID).

Therefore, in a case of an example in FIG. 3, it is shown that a management target apparatus 5 to which the apparatus ID “Apparatus 1” is assigned is an apparatus of an apparatus model called “Model 1,” belongs to an organization 2 called “1,” and is managed by a management apparatus (the operation management apparatus 4 or an intra-organization management apparatus 6) to which the management apparatus ID “Operation Management Apparatus” is assigned.

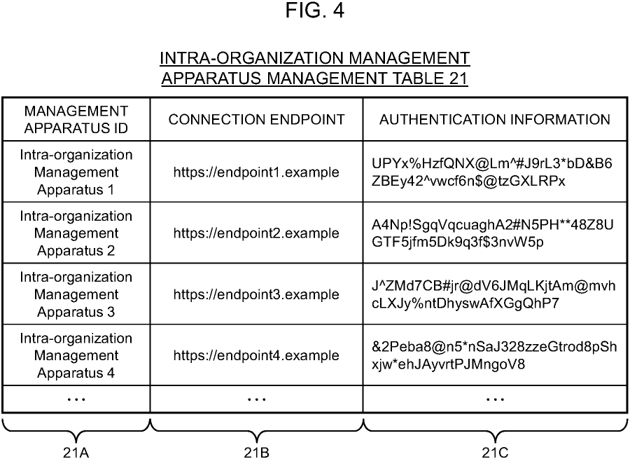

Moreover, the intra-organization management apparatus management table 21: is a table used to manage the respective intra-organization management apparatuses 6 existing within the computer system 1; and stores necessary information for accessing these intra-organization management apparatuses 6. Specifically speaking, the intra-organization management apparatus management table 21 is configured by including, as illustrated in FIG. 4, a management apparatus ID column 21A, a connection endpoint column 21B, and an authentication information column 21C. In the intra-organization management apparatus management table 21, one record (row) corresponds to one intra-organization management apparatus 6 existing within the computer system 1.

Then, the management apparatus ID column 21A stores a unique identifier of the relevant intra-organization management apparatus 6 (a management apparatus ID), which is assigned to the relevant intra-organization management apparatus 6. Furthermore, the connection endpoint column 21C stores the address of the relevant intra-organization management apparatus 6 on the network 3 (FIG. 1); and the authentication information column 21C stores authentication information such as an access token for the relevant intra-organization management apparatus 6 to identify the operation management apparatus 4.

Therefore, in a case of an example in FIG. 4, it is shown that, for example, regarding a record to which the management apparatus ID “1” is assigned, the address of an intra-organization management apparatus 6 called “Intra-organization Management Apparatus 1” is “https://endpoint1.example” and the authentication information of the operation management apparatus 4 in the relevant intra-organization management apparatus 6 is “UPYx%HzfQNX@Lm^#J9rL3*bD&B6ZBEy42^vwcf6n$@tzGXLRPx.”

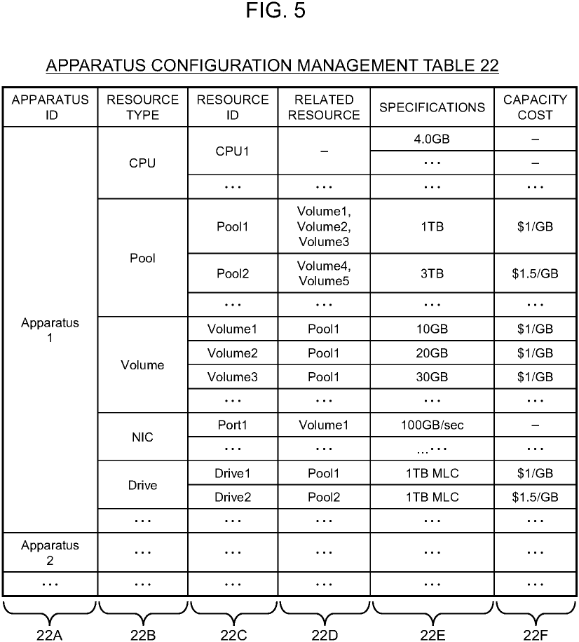

The apparatus configuration management table 22: is a table used to manage configuration information of each management target apparatus 5 which is acquired by the operation management apparatus 4 directly from each management target apparatus 5 or indirectly via the relevant intra-organization management apparatus 6; and is configured by including, as illustrated in FIG. 5, an apparatus ID column 22A, a resource type column 22B, a resource ID column 22C, a related resource column 22D, a specifications column 22E, and a capacity cost column 22F.

Then, the apparatus configuration management table 22 is provided with apparatus ID fields 22A associated with the respective management target apparatuses 5 within the computer system 1 and these apparatus ID fields 22A store the apparatus ID’s of the respective corresponding management target apparatuses 5.

Moreover, the apparatus configuration management table 22 is provided with resource type fields 22B respectively associated with resource types of various kinds of resources such as CPU’s, pools, volumes, and NIC’s included in each management target apparatus 5 and these resource type fields 22B store the names of the respective corresponding resource types.

Furthermore, each resource ID field 22C corresponding to each resource type field 22B is divided according to the respective resources of the relevant resource types included in the relevant management target apparatus 5 (for example, if there are two CPU’s, the resource ID column 22C is divided into two fields; and if there are three CPU’s, the resource ID column 22C is divided into three fields); and each of these divided resource ID fields 22C stores a unique identifier of the relevant resource (a resource ID), which is assigned to the relevant resource.

Moreover, related resource fields 22D: are provided respectively corresponding to their respective resource ID fields 22C; and respectively stores resource ID’s of all the resources related to resources whose resource ID’s are stored in the relevant resource ID fields 22C. For example, if the resource type is a “Pool,” identifiers of all volumes included in that “Pool” (volume ID’s) are stored in the related resource column 22D; and contrarily, if the resource type is a “Volume,” a pool ID of a pool including that “Volume” is stored in the related resource field 22D.

Furthermore, a specifications field 22E and a capacity cost field 22F are provided respectively corresponding to each resource ID field 22C of the relevant management target apparatus 5. Then, the specifications field 22E stores the specifications of a resource whose resource ID is stored in the corresponding resource ID field 22C; and the capacity cost field 22F stores the cost per unit capacity (1 GB) when the relevant resource is a storage area or a storage device.

Therefore, in a case of an example in FIG. 5, it is shown that, for example, the related resources of a “Pool” called “Pool 1” of a management target apparatus 5 to which the apparatus ID “Apparatus 1” is assigned are “Volume 1,” “Volume 2,” and “Volume 3” (that is, “Pool 1” includes three volumes “Volume 1,” “Volume 2” and “Volume 3”), and the capacity of that “Pool” is “1TB,” and the capacity cost “$⅟GB.”

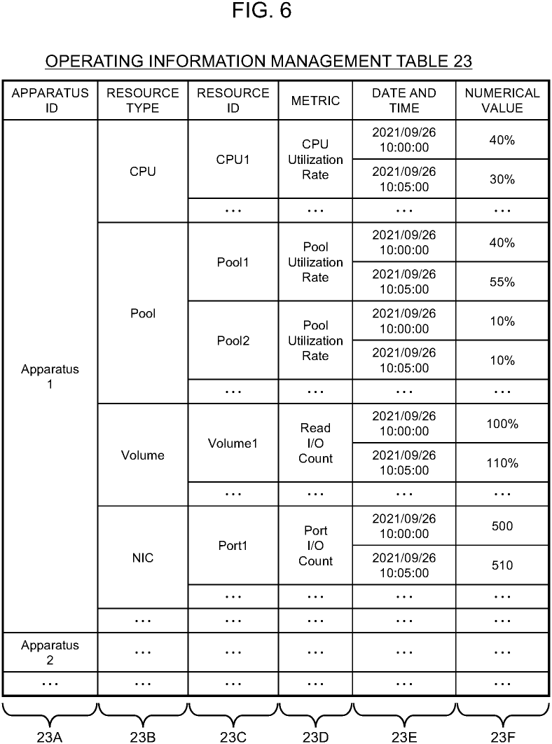

The operating information management table 23: is a table used to manage operating information of each management target apparatus 5, which is acquired by the operation management apparatus 4 directly from each management target apparatus 5 or indirectly via an intra-organization management apparatus 6; and is configured by including, as illustrated in FIG. 6, an apparatus ID column 23A, a resource type column 23B, a resource ID column 23C, a metric column 23D, a date-and-time column 23E, and a numerical value column 23F.

Then, the operating information management table 23 is provided with apparatus ID fields 22A respectively associated with the respective management target apparatuses 5 within the computer system 1 and apparatus ID’s of the corresponding management target apparatuses 5 are respectively stored in these apparatus ID fields 23A.

Moreover, the operating information management table 23 is provided with resource type fields 23B respectively associated with resource types of various kinds of resources such as CPU’s, pools, volumes, and NIC’s included in each management target apparatus 5 and these resource type fields 23B store the names of the respective corresponding resource types.

Furthermore, each resource ID field 23C corresponding to each resource type field 23B is divided according to the respective resources of the relevant resource types included in the relevant management target apparatus 5 and each of these divided resource ID fields 23C stores the resource ID of the relevant resource.

Moreover, each of metric fields 23D is provided corresponding to each resource ID column 23C. Then, these metric fields 23D store the metric types of the corresponding resources. Furthermore, a date-and-time field 23E and a numerical value field 23F are provided respectively corresponding to the date and time when the corresponding metric of to the relevant management target apparatus 5 was acquired. Then, the date-and-time field 23E stores the date and time when the corresponding metric of the relevant management target apparatus 5 was acquired from the relevant management target apparatus 5 or the intra-organization management apparatus 6; and the numerical value field 23F stores a value of the relevant metric acquired on that date and time.

Therefore, in a case of an example in FIG. 6, for example, it is shown that a “CPU Utilization Rate” of a “CPU” called “CPU 1” for the management target apparatus 5 to which the apparatus ID “Apparatus 1” is assigned was “40%” at the time point of “10:00:00 on 2021/09/26” and was “30%” at the time point of “10:05:00 on 2021/09/26.”

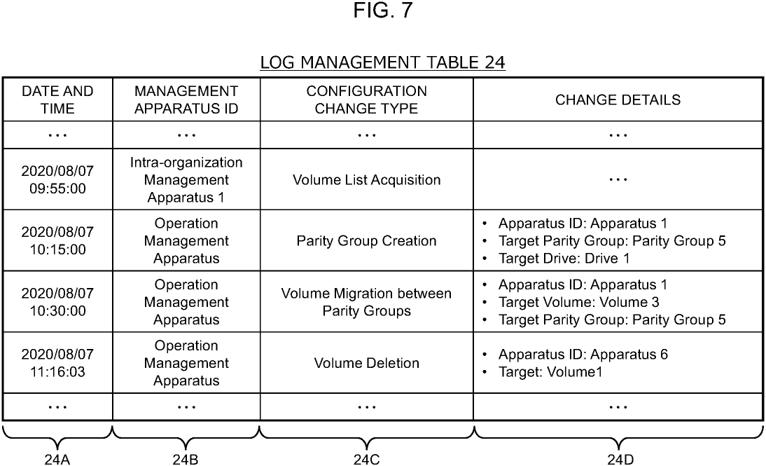

The log management table 24: is a table used to retain log information of logs regarding configuration changes performed with respect to the management target apparatuses 5; and is configured by including, as illustrated in FIG. 7, a date-and-time column 24A, a management apparatus ID column 24B, a configuration change type column 24C, and a change details column 24D. In the log management table 24, one record (row) corresponds to one configuration change which was performed with respect to the management target apparatus 5.

Then, the date-and-time column 24A stores the date and time when the relevant configuration change was started. Furthermore, the management apparatus ID column 24B stores a management apparatus ID of a management apparatus (the operation management apparatus 4 or an intra-organization management apparatus 6) which manages a management target apparatus 5 at which an anomaly has occurred; and the change type column 24C stores the type of the configuration change (configuration change type) executed with respect to the relevant anomaly. Furthermore, the change details column 24D stores, as change details, information such as the management target apparatus 5 regarding which the relevant configuration change was performed, and the position within that management target apparatus 5 where the configuration change was performed.

Therefore, in a case of an example in FIG. 7, it is shown that, for example, regarding the management target apparatus 5 called “Apparatus 1” managed by the “Operation Management Apparatus,” a configuration change of a configuration change type that is “Parity Group Creation” to create a new parity group called “Parity Group 5” from a storage area provided by a storage device, such as a hard disk drive or an SSD, which is called “Drive 1” of the relevant management target apparatus 5 was conducted at “10:15:00 on 2020/08/07.”

Moreover, FIG. 7 shows that subsequently, regarding the management target apparatus 5 (“Apparatus 1”), a configuration change of a configuration change type that is “Volume Migration between Parity Groups” to migrate a volume called “Volume 3” to the newly created parity group called “Parity Group 5” as described above was conducted at “10:30:00 on 2020/08/07.”

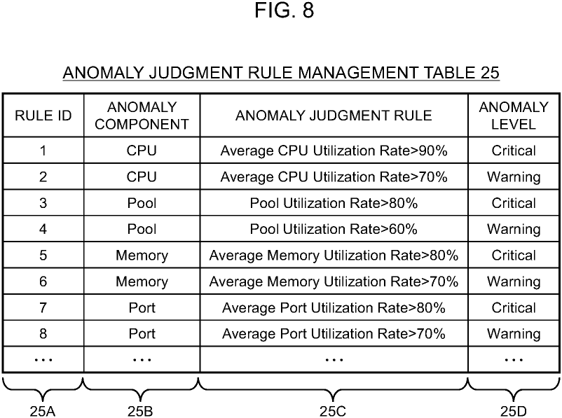

The anomaly judgment rule management table 25: is a table in which various kinds of previously defined rules for judging whether each management target apparatus 5 within the computer system 1 is anomalous or not (hereinafter referred to as “anomaly judgment rules”) are registered; and is configured by including, as illustrated in FIG. 8, a rule ID column 25A, an anomaly component column 25B, an anomaly judgment rule column 25C, and an anomaly level column 25D. In the anomaly judgment rule management table 25, one record (row) corresponds to one anomaly judgment rule.

Then, the rule ID column 25A stores a unique identifier of the relevant anomaly judgment rule (a rule ID), which is assigned to that anomaly judgment rule; and the anomaly component column 25B stores the position within the management target apparatus 5 which is a target to judge whether an anomaly exists or not according to the anomaly judgment rule.

Moreover, the anomaly judgment rule column 25C stores the relevant anomaly judgment rule; and the anomaly level column 25D stores an anomalous degree of the relevant position when the relevant position is judged to be anomalous according to the relevant anomaly judgment rule (hereinafter referred to as an “anomaly level”). Incidentally, examples of the anomaly level include “Critical” meaning that there is a significant anomaly at the relevant position, and “Warning” meaning that there is an anomaly of a warning degree.

Therefore, in a case of an example in FIG. 8, it is shown that, for example, an anomaly judgment rule to which the rule ID “1” is assigned can determine that an anomaly of the “Critical” level has occurred at a “CPU” when an “Average CPU Utilization Rate > 90% (the average CPU utilization rate is larger than 90%).”

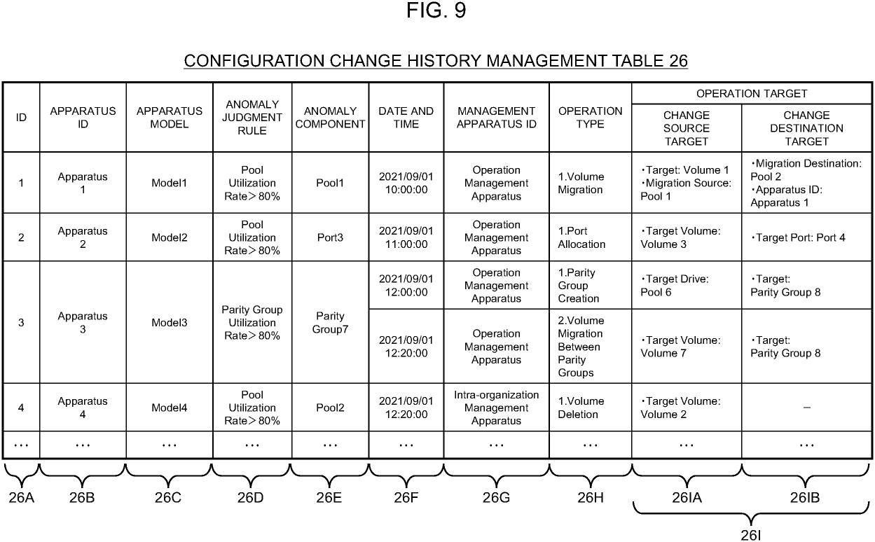

The configuration change history management table 26: is a table used to extract and retain configuration changes, which were performed as countermeasures against anomalies that occurred within the computer system 1, from the log management table 24 (FIG. 7); and is configured by including, as illustrated in FIG. 9, an ID column 26A, an apparatus ID column 26B, an apparatus model column 26C, an anomaly judgment rule column 26D, an anomaly component column 26E, a date-and-time column 26F, a management apparatus ID column 26G, an operation type column 26H, and an operation target column 261. In the configuration change history management table 26, one record (row) corresponds to a history of a series of configuration changes performed as the countermeasures against the anomaly which occurred in the past (hereinafter referred to as a “configuration change history”).

Then, the ID column 26A stores a unique identifier of the relevant configuration change history, which is assigned in the configuration change history management table 26 to the relevant configuration change history extracted from the log management table 24 (FIG. 7). Furthermore, the apparatus ID column 26B stores the apparatus ID of a management target apparatus 5 regarding which the relevant configuration change was performed; and the apparatus model column 26C stores the name of an apparatus model of the relevant management target apparatus 5.

The anomaly judgment rule column 26D stores an anomaly judgment rule used to judge the anomaly then; and the anomaly component column 26E stores an anomaly component of the relevant the management target apparatus 5 which is judged to be anomalous by that anomaly judgment rule. Furthermore, the date-and-time column 26F stores a date and time when the relevant configuration change was started; and the management apparatus ID column 26G stores a management apparatus ID of a management apparatus (the operation management apparatus 4 or an intra-organization management apparatus 6) which performed operations of the relevant configuration change.

Furthermore, the operation type column 26H stores an operation type of the relevant configuration change. Examples of this kind of operation type include: “Volume Migration” to migrate a volume to another pool within the same storage apparatus or to another storage apparatus; “Compression & Deduplication” to compress data and eliminate any redundant data; “Pool Expansion (Drive Addition)” to increase the capacity of a specific pool by adding a drive; “Port Allocation” to allocate a port to a certain volume; and “Parity Group Addition” to add a parity group.

The operation target column 26I is divided into a change source target column 26IA and a change destination target column 26IB. Then, the change source target column 26IA stores information about a change source of the configuration change; and the change destination target column 26IB stores information about a change destination of the configuration change. For example, when the operation type is the “Volume Migration,” the change source target column 26IA stores the volume ID of a volume which is a migration source, and the pool ID of a pool associated with that volume; and the change destination target column 26IB stores the pool ID of a pool associated with a volume created as a migration destination.

Therefore, in a case of an example in FIG. 9, it is shown that, for example, as a configuration change history to which the ID “1” is assigned, an anomaly which satisfies the anomaly judgment rule specifying that the “Pool Utilization Rate > 80%” was detected in “Pool 1” of the management target apparatus 5 called “Apparatus 1” of an apparatus model called “Model 1,” and the “Operation Management Apparatus” handled this anomaly by performing the operation called the “Volume Migration” with respect to the above-mentioned anomaly at “10:00:00 on 2021/09/01” to create a volume associated with a pool called “Pool 2” within the same storage apparatus 5A and migrate data, which is stored in “Volume 1” associated with “Pool 1,” to the above-created volume.

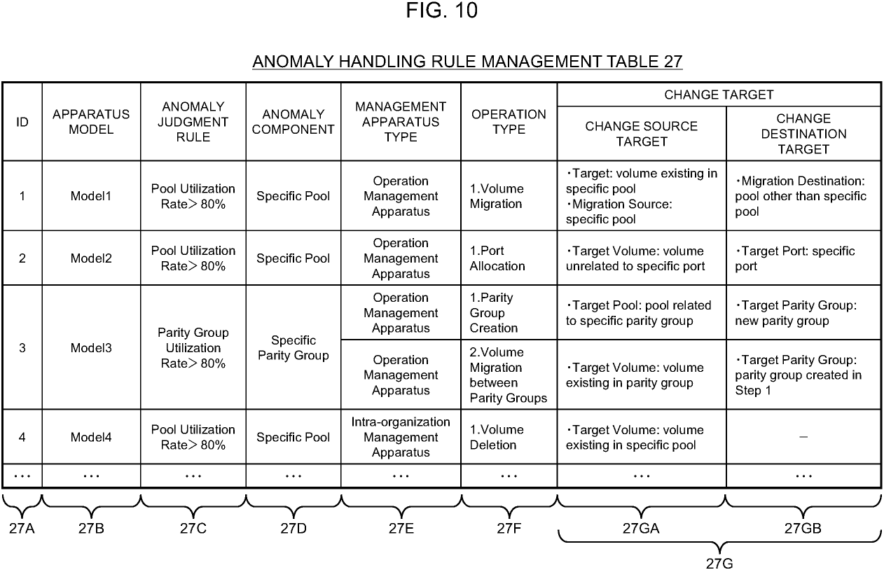

The anomaly handling rule management table 27: is a table used to manage the content of the respective configuration change histories (the content of the configuration changes) which are stored in the configuration change history management table 26, and are generalized, as the anomaly handling rules; and is configured by including, as illustrated in FIG. 10, an ID column 27A, an apparatus model column 27B, an anomaly judgment rule column 27C, an anomaly component column 27D, a management apparatus type column 27E, an operation type column 27F, and a change target column 27G. In the anomaly handling rule management table 27, one record (row) corresponds to one anomaly handling rule.

Then, the ID column 27A stores a unique identifier of the relevant anomaly handling rule (an anomaly handling the rule ID), which is assigned to the relevant anomaly handling rule in the anomaly handling rule management table 27; and the apparatus model column 27B stores an apparatus model of a management target apparatus 5 regarding which the relevant configuration change was performed.

Moreover, the anomaly judgment rule column 27C stores an anomaly judgment rule used when an anomaly of the relevant management target apparatus 5 was detected; and the anomaly component column 27D stores the position of that anomaly detected in the relevant management target apparatus 5 according to the anomaly judgment rule (an anomaly component).

Furthermore, the operation type column 27F stores an operation type of a configuration change performed to solve the relevant anomaly; and the management apparatus ID column 27E stores the type (the operation management apparatus or an intra-organization management apparatus) of a management apparatus (the operation management apparatus 4 or an intra-organization management apparatus 6) which performed the operations of that operation type.

The change target column 27G is divided into a change source target column 27GA and a change destination target column 27GB. Then, the change source target column 27GA stores information obtained by generalizing a resource which is a change source for the relevant configuration change; and the change destination target column 27GB stores information obtained by generalizing a resource which is a change destination of the relevant configuration change.

Therefore, in a case of an example in FIG. 10, it is shown that, for example, an anomaly handling rule to which the ID “1” is assigned is an anomaly handling rule specifying that an anomaly which satisfies an anomaly judgment rule specifying the “Pool Utilization Rate > 80%” was detected in a “Specific Pool” in an apparatus of an apparatus model called “Model 1″and the anomaly was solved by executing the “Volume Migration,” as a countermeasure against this anomaly, to migrate a “Volume Existing in Specific Pool” to a “Pool Other Than the Specific Pool” as operated by the “Operation Management Apparatus.”

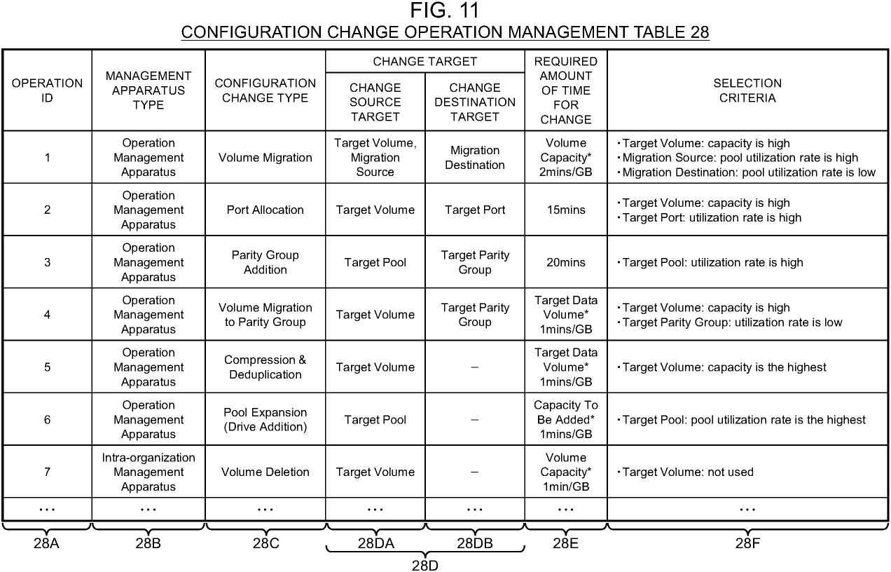

The configuration change operation management table 28: is a table in which the content of configuration change operations for each previously defined configuration change type (such as a change target and a required amount of time for change, and selection criteria for a change source and a change destination) is registered; and is configured by including, as illustrated in FIG. 11, an operation ID column 28A, a management apparatus type column 28B, a configuration change type column 28C, a change target column 28D, a required-amount-of-time-for-change column 28E, and a selection criteria column 28F. In the configuration change operation management table 28, one record (row) corresponds to a specific configuration change operation to perform the configuration change of one configuration change type.

Then, the operation ID column 28A stores an identifier assigned to the relevant configuration change operation in the configuration change operation management table 28; and the management apparatus type column 28B stores an management apparatus type of a management apparatus (the operation management apparatus 4 or an intra-organization management apparatus 6) which should perform that configuration change operation. Furthermore, the configuration change type column 28C stores the name of the relevant configuration change type.

The change target column 28D is divided into a change source target column 28DA and a change destination target column 28DB; the change source target column 28DA stores a change source target when performing a configuration change of the relevant configuration change type (hereinafter referred to as the “change source target”); and the change destination target column 28DB stores a change destination target (hereinafter referred to as the “change destination target”).

Furthermore, the required-amount-of-time-for-change column 28E stores a general amount of time required for the configuration change of the relevant configuration change type; and the selection criteria column 28F stores selection criteria for the change source target and the change destination target. Incidentally, the selection criteria do not necessarily have to be defined in advance and may be created or updated dynamically according to updates during the operation or operation histories or the like.

Therefore, in a case of an example in FIG. 11, it is shown that the following are defined: for example, a configuration change operation to which the operation ID “1” is assigned is an operation regarding a configuration change of the configuration change type called the “Volume Migration” which is performed under control of the “Operation Management Apparatus”; the “Volume Migration” is the configuration change to perform the operation to migrate a “Pool” associated with a “Volume” which is a target (the target is the “Volume” and a migration source and a migration destination are “Pools”); the required amount of time is approximately “2 mins/GB” according to the “Volume Capacity”; and a volume whose “capacity is large” Volume should be a target volume, a pool whose “utilization rate is high” should be a migration source pool, and a pool whose “utilization rate is low” should be a migration destination pool.

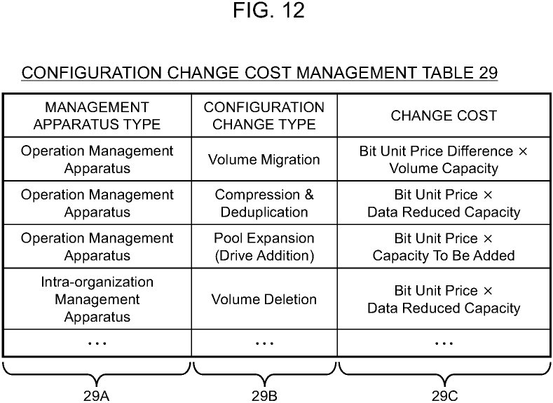

The configuration change cost management table 29: is a table in which a cost required for a configuration change of each configuration change type (hereinafter referred to as a “change cost”) is registered in advance; and is configured by including, as illustrated in FIG. 12, a management apparatus type column 29A, a configuration change type column 29B, and a change cost column 29C. In the configuration change cost management table 29, one record (row) corresponds to one configuration change type.

Then, the configuration change type column 29B stores the name of the relevant configuration change type; and the management apparatus type column 29A stores the name of a management apparatus (the operation management apparatus 4 or an intra-organization management apparatus 6) which performs a configuration change operation of that configuration change type. Furthermore, the change cost column 29C stores an arithmetic expression for calculating the cost required when performing the configuration change of the relevant change type (the change cost).

Therefore, in a case of an example in FIG. 12, it is shown that the following is defined: the “Volume Migration” is performed under control of the operation management apparatus 4 and the change cost can be calculated as a result of multiplication of the difference in a bit unit price (cost required to store one-bit data) between the migration source and the migration destination, by the capacity of a migration target volume.

The proposed countermeasure evaluation function management table 30 is a table which stores various kinds of evaluation functions to evaluate a candidate proposed countermeasure against the latest anomaly, which was generated by using the same or similar anomaly handling rule registered in the anomaly handling rule management table 27.

In a case of this embodiment, the evaluation of a candidate proposed countermeasure is conducted based on the following three evaluation criteria: an anomaly improvement rate when a countermeasure, which is the candidate proposed countermeasure, is executed (hereinafter referred to as the “anomaly improvement rate”); an amount of time required to execute the countermeasure which is the candidate proposed countermeasure (hereinafter referred to as the “required amount of time”); and the change cost required to execute the countermeasure which is the candidate proposed countermeasure.

The anomaly improvement rate is calculated by a simulation and the required amount of time is calculated by using the required amount of time stored in the relevant required-amount-of-time-for-change column 28E (FIG. 11) of the configuration change operation management table 28 (FIG. 11). Furthermore, the change cost is calculated by using the arithmetic expression stored in the relevant change cost column 29C (FIG. 12) of the configuration change cost management table 29 (FIG. 12).

Then, in this embodiment, each of these calculated values of the anomaly improvement rate, the required amount of time, and the change cost is formed into an indexation value within the range from -1 to 0 or from 0 to 1; and each candidate proposed countermeasure is evaluated by using these indexation values of the anomaly improvement rate, the required amount of time, and the change cost, and the evaluation results together with the candidate proposed countermeasure are presented to the user.

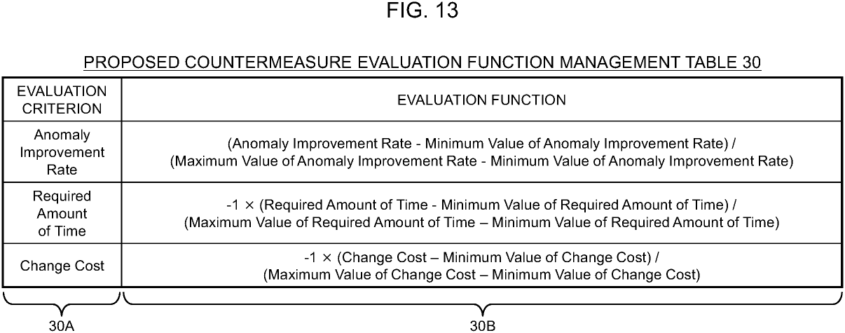

The proposed countermeasure evaluation function management table 30: is a table in which arithmetic expressions for forming the anomaly improvement rate, the required amount of time, and the change cost into the indexation values are stored in advance respectively as evaluation functions; and is configured by including, as illustrated in FIG. 13, an evaluation criterion column 30A and an evaluation function column 30B. In the proposed countermeasure evaluation function management table 30, one record (row) corresponds to one evaluation criterion (the anomaly improvement rate, the required amount of time, or the change cost).

Then, the evaluation criterion column 30A stores the name of the relevant evaluation criterion and the evaluation function column 30B stores an evaluation function for calculating that evaluation criterion.

Therefore, in a case of an example in FIG. 13, the evaluation function of the anomaly improvement rate is the following expression.

$$\begin{matrix}\text{Anomaly Imporvement Rate -} \\ \text{Minimum Value of Anomaly Improvement Rate} \\ \text{Maximum Value of Anomaly Improvement Rate -} \\ \text{Minimum Value of Anomaly Improvement Rate}\end{matrix} \qquad \text{[Math. 1]}$$

The evaluation function of the required amount of time is the following function.

$$\begin{matrix}\text{-1} \times \text{Required Amount of Time -} \\ \text{Minimum Value of Required Amount of Time} \\ \text{Maximum Value of Required Amount of Time} - \\ \text{Minimum Value of Required Amount of Time}\end{matrix} \qquad \text{[Math. 2]}$$

The evaluation function of the change cost is the following function.

$$\begin{matrix}\text{-1} \times \text{Change Cost} - \text{Minimum Value of Change Cost} \\ \text{Maximum Value of Change Cost} - \\ \text{Minimum Value of Change Cost}\end{matrix} \qquad \text{[Math. 3]}$$

Meanwhile, the apparatus information collection program 31 is a program having a function that collects the configuration information and the operating information of each management target apparatus 5 directly or indirectly via the intra-organization management apparatus 6 within the same organization as that of the relevant management target apparatus 5. The apparatus information collection program 31 stores the collected configuration information of each management target apparatus 5 in the apparatus configuration management table 22 (FIG. 5) and also stores the collected operating information of each management target apparatus 5 in the operating information management table 23 (FIG. 6).

Moreover, the anomaly detection program 32 is a program having a function that detects an anomaly which has occurred at each management target apparatus 5 on the basis of the operating information of each management target apparatus 5, which is stored in the operating information management table 23, and the anomaly judgment rules stored in the anomaly judgment rule management table 25 (FIG. 8). When the anomaly detection program 32 detects an anomaly at any of the management target apparatuses 5, it notifies the proposed countermeasure presentation program 33 to that effect.

The proposed countermeasure presentation program 33 is a program having a function that presents some candidate proposed countermeasures against the latest anomaly to the user. Practically, the proposed countermeasure presentation program 33: searches the anomaly handling rule management table 27 (FIG. 10) for the anomaly handling rules which are applicable to the anomaly detected by the anomaly detection program 32; and generates one or a plurality of candidate proposed countermeasures against the latest anomaly according to the anomaly handling rules detected by the search. Furthermore, the proposed countermeasure presentation program 33 presents the generated candidate proposed countermeasures as proposed countermeasures against the latest anomaly to the user.

Under this circumstance, regarding each candidate proposed countermeasure, the proposed countermeasure presentation program 33 calculates the anomaly improvement rate, the required amount of time, and the change cost when executing a countermeasure which is the relevant candidate proposed countermeasure, by means of a simulation or the like. Then, the proposed countermeasure presentation program 33 ranks the respective candidate proposed countermeasures on the basis of the calculated anomaly improvement rate, the calculated required amount of time, and the calculated change cost of each candidate proposed countermeasure and presents each candidate proposed countermeasure together with its rank to the user.

The configuration change execution program 34 is a program having a function that executes the configuration change processing for changing the configuration of the management target apparatus 5 at which an anomaly has occurred, by executing a candidate proposed countermeasure selected by the user from among the candidate proposed countermeasures presented by the proposed countermeasure presentation program 33. The configuration change execution program 34 records the content of the executed configuration change processing in the log management table 24 (FIG. 7) and updates the apparatus configuration management table 22 according to the content of the executed configuration change processing.

Moreover, the log collection program 35 is a program having a function that collects, from each intra-organization management apparatus 6, the log information of logs regarding configuration changes which the configuration change execution program 34 cannot record in the log management table 24 (for example, configuration changes performed with respect to each management target apparatus 5 within the organization 2, to which the relevant intra-organization management apparatus 6 belongs, for example, by the user by operating that intra-organization management apparatus 6). The log collection program 35 stores the collected log information in the log management table 24.

The configuration change extraction program 36 is a program having a function that extracts, from the log management table 24, the log information of logs regarding configuration changes performed with respect to a management target apparatus 5, at which an anomaly has occurred, to solve the anomaly during a period of time after the anomaly occurred until it was solved, by referring to the configuration change operation management table 28 (FIG. 11). The configuration change extraction program 36 records various kinds of information included in the extracted log information and other necessary information as a configuration change history in the configuration change history management table 26 (FIG. 9).

The anomaly handling rule generation program 37 is a program having a function that generates the anomaly handling rules by generalizing the content of each configuration change history stored in the configuration change history management table 26 and records the generated anomaly handling rules in the anomaly handling rule management table 27 (FIG. 10). The proposed countermeasure presentation program 33 generates some candidate proposed countermeasures against the latest anomaly according to the anomaly handling rules recorded in this anomaly handling rule management table 27 as described earlier.

### Various Kinds of Processing Executed in Relation to Anomaly Handling Function

Next, an explanation will be provided about the content of a series of processing executed by the operation management apparatus 4 in relation to such anomaly handling function (hereinafter referred to as “anomaly handling and anomaly handling rule generation processing”). Incidentally, the following explanation will be provided by referring to a processing subject of the various kinds of processing as a “program”; however, it is needless to say that practically, the CPU 10 (FIG. 2) for the operation management apparatus 4 executes the processing according to that program.

### 1) Flow of Anomaly Handling and Anomaly Handling Rule Generation Processing

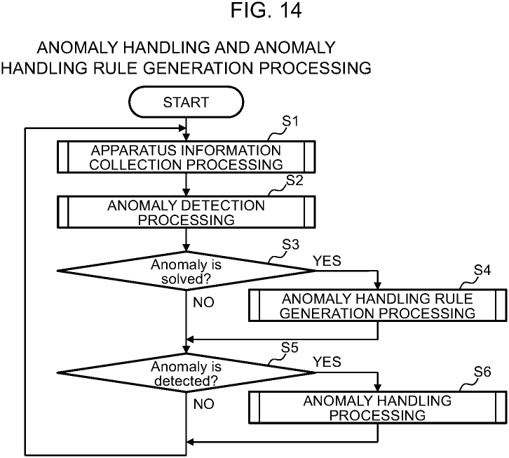

FIG. 14 illustrates a flow of the anomaly handling and anomaly handling rule generation processing. This anomaly handling and anomaly handling rule generation processing is started when the power of the operation management apparatus 4 is turned on; and the apparatus information collection program 31 (FIG. 2) firstly executes apparatus information collection processing for directly or indirectly collecting each piece of the configuration information and the operating information of all the management target apparatuses 5 existing within the computer system 1, and recording the collected configuration information and operating information in the apparatus configuration management table 22 (FIG. 5) and the operating information management table 23 (FIG. 6) (S1).

Next, the anomaly detection program 32 (FIG. 2) executes anomaly detection processing for detecting an anomaly which has occurred at any one of the management target apparatuses 5 on the basis of the operating information of each management target apparatus 5, which is stored in the operating information management table 23, and each anomaly judgment rule stored in the anomaly judgment rule management table 25 (FIG. 8) (S2).

Subsequently, the anomaly detection program 32 judges whether any one of the anomalies which have been detected so far is solved or not (S3). Then, if a negative result is obtained in this judgment, the processing proceeds to step S5.

On the other hand, if an affirmative result is obtained in the judgment of step S3, the anomaly handling rule generation program 37 (FIG. 2) executes anomaly handling rule generation processing for generating an anomaly handling rule against the anomaly by generalizing a series of configuration changes performed regarding the solved anomaly with respect to the relevant management target apparatus 5 in order to solve the anomaly after the occurrence of the anomaly until it is solved, and storing the generated anomaly handling rule in the anomaly handling rule management table 27 (FIG. 10) (S4).

Subsequently, the anomaly detection program 32 judges whether or not an anomaly was detected in the anomaly detection processing in step S2 (S5). Then, if a negative result is obtained in this judgment, the processing returns to step S1 and then the processing in step S1 and subsequent steps is executed repeatedly in the same manner as described above.

On the other hand, if an affirmative result is obtained in the judgment of step S5, the sequence of the anomaly handling processing for generating one or a plurality of candidate proposed countermeasures against the anomaly detected in step S2 according to the anomaly handling rules stored in the anomaly handling rule management table 27 and presenting them to the user, and executing the handling processing on the basis of the candidate proposed countermeasure selected by the user from among the presented candidate proposed countermeasures is executed by the proposed countermeasure presentation program 33 and the configuration change execution program 34 (S6). Subsequently, the processing returns to step S1 and then the processing in step S1 and subsequent steps is executed repeatedly in the same manner as described above.

### 1-2) Apparatus Information Collection Processing

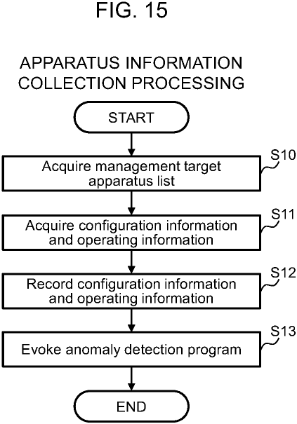

FIG. 15 illustrates specific processing content of the apparatus information collection processing executed by the apparatus information collection program 31 in step S1 of the anomaly handling and anomaly handling rule generation processing described above with reference to FIG. 14. This apparatus information collection processing is started when the processing proceeds to step S2 of the anomaly handling and anomaly handling rule generation processing; and the apparatus information collection program 31 (FIG. 2) firstly acquires a list of the management target apparatuses 5 from the management target management table 20 (FIG. 3) (S10).

Subsequently, the apparatus information collection program 31 acquires the configuration information and the operating information of the relevant management target apparatus 5, respectively, directly from each management target apparatus 5 included in the list acquired in step S10 or indirectly via the relevant intra-organization management apparatus 6 (FIG. 1) (S11).

Then, the apparatus information collection program 31 records the acquired configuration information of each management target apparatus 5 in the apparatus configuration management table 22 (FIG. 5) and records the acquired operating information of each management target apparatus 5 in the operating information management table 23 (FIG. 6), respectively (S12), then invokes the anomaly detection program 32 (FIG. 2) (S13), and subsequently terminates this apparatus information collection processing.

### 1-3) Anomaly Detection Processing

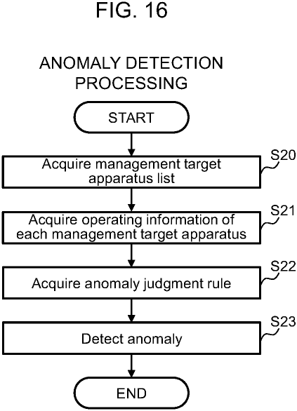

FIG. 16 illustrates specific processing content of the anomaly detection processing executed in step S2 of the anomaly handling and anomaly handling rule generation processing by the anomaly detection program 32 which is invoked by the apparatus information collection program 31 in step S13 of the above-described apparatus information collection processing.

Having been invoked by the apparatus information collection program 31, the anomaly detection program 32 starts this anomaly detection processing and firstly acquires a list of management target apparatuses 5 from the management target management table 20 (FIG. 3) (S20).

Subsequently, the anomaly detection program 32 acquires the operating information of each management target apparatus 5 from the operating information management table 23 (S21) and further acquires all the anomaly judgment rules from the anomaly judgment rule management table 25 (FIG. 6) (S22).

Next, the anomaly detection program 32 detects all the management target apparatuses 5, at which anomalies have occurred, and all the anomalies on the basis of the operating information of each management target apparatus 5 acquired in step S21 and each of the anomaly judgment rules acquired in step S22 (S23).

Specifically speaking, the anomaly detection program 32 selects one unprocessed anomaly judgment rule from among the anomaly judgment rules acquired in step S22, sequentially compares that anomaly judgment rule with the operating information of each management target apparatus 5, and thereby sequentially judges whether is any management target apparatus 5 which can be determined according to that anomaly judgment rule that an anomaly has occurred. Then, the anomaly detection program 32 extracts all the management target apparatuses 5 which can be determined by this judgment that an anomaly/anomalies has occurred there, and all the anomalies.

Moreover, regarding the other remaining anomaly judgment rules, the anomaly detection program 32 judges in the same manner whether there is any management target apparatus 5 which can be determined that an anomaly/anomalies has occurred, according to the relevant anomaly judgment rule. Then, the anomaly detection program 32 extracts all the management target apparatuses 5 which can be determined by this judgment that an anomaly/anomalies has occurred there, and all the anomalies.

Then, after the anomaly detection program 32 completes judging whether an anomaly/anomalies exists or not, with respect to all combinations of the respective anomaly judgment rules and the respective management target apparatuses 5, it terminates this anomaly detection processing.

### 1-4) Anomaly Handling Rule Generation Processing

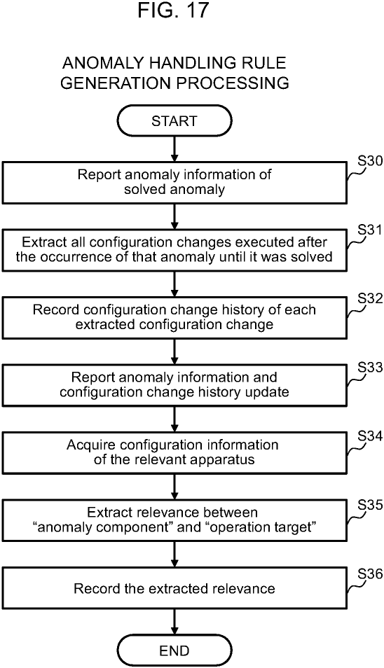

FIG. 17 illustrates specific processing content of the anomaly handling rule generation processing executed in step S4 of the anomaly handling and anomaly handling rule generation processing described earlier with reference to FIG. 14.

If an affirmative result is obtained in step S3 of the anomaly handling and anomaly handling rule generation processing, this anomaly handling rule generation processing is started; and the anomaly detection program 32 firstly notifies the configuration change extraction program 36 (FIG. 2) of information about the anomaly detected as being solved in step S3 of the anomaly handling and anomaly handling rule generation processing, as anomaly information (S30).

Specifically speaking, the anomaly detection program 32 notifies the configuration change extraction program 36 of information, as the anomaly information, such as a date and time when the relevant anomaly occurred, the apparatus ID of the management target apparatus 5 at which the anomaly occurred, the management apparatus ID of an management apparatus (the operation management apparatus 4 or an intra-organization management apparatus 6) which manages that management target apparatus 5, the anomaly judgment rule used to detect the relevant anomaly, and the position where the anomaly occurred (the anomaly component).

Subsequently, the configuration change extraction program 36 refers to the configuration change operation management table 28 (FIG. 11) and extracts, from the log management table 24 (FIG. 7), logs regarding all configuration changes performed with respect to the relevant management target apparatus 5 in order to solve the anomaly during a period of time after the anomaly regarding which the anomaly information was reported occurred until that anomaly was solved (S31). For example, the configuration change extraction program 36 extracts the logs from a time of day when the anomaly was detected until a time of day when the anomaly was solved.

Moreover, as other means, there is also a possible method of causing the configuration change extraction program 36 to have an anomaly-judgment-rule-and-countermeasure correspondence table which associates each anomaly judgment rule with a countermeasure (a series of configuration changes) normally executed against the anomaly detected according to that anomaly judgment rule and which is not illustrated in the drawing. For example, regarding an anomaly detected according to an anomaly judgment rule specifying “Parity Group Utilization Rate > 80%,” a configuration change called “Parity Group Addition” to add a new parity group to solve the anomaly and a configuration change called “Volume Migration to Parity Group” to migrate a volume in a parity group, in which the anomaly was detected, to a new parity group are sequentially performed (see FIG. 7). Consequently, in the anomaly-judgment-rule-and-countermeasure correspondence table, a countermeasure composed of the configuration changes called the “Parity Group Addition” and the “Volume Migration to Parity Group” is associated with the anomaly judgment rule specifying “Parity Group Utilization Rate > 80%.”

Incidentally, for example, concerning an anomaly regarding which the pool utilization rate is higher than a threshold value, there are: a volume migration countermeasure to migrate a volume associated with the relevant pool to another pool (“Volume Migration”); a countermeasure to deduplicate and compress data within that pool (“Deduplication & Compression”); and a countermeasure to add the capacity of that pool (“Pool Expansion”). Accordingly, in the anomaly-judgment-rule-and-countermeasure correspondence table, a plurality of countermeasures (a series of configuration changes) are sometimes associated with one anomaly judgment rule; and, for example, three countermeasures, that is, “Volume Migration,” “Deduplication & Compression,” and “Pool Expansion” are associated with the anomaly judgment rule specifying “Pool Utilization Rate > 80%.”

Consequently, in this case in step S32, the configuration change extraction program 36: firstly decides a search range with the anomaly occurrence date and time (decides the range to be on and after the anomaly occurrence date and time) on the basis of the anomaly occurrence date and time included in the anomaly information reported from the anomaly detection program 32 in step S31, and the anomaly judgment rule used to detect that anomaly; and then refers to the anomaly-judgment-rule-and-countermeasure correspondence table and extracts all the necessary logs from the log management table 24 by extracting the respective logs which are logs within the decided search range and which correspond to all the configuration changes that match the countermeasures associated with the anomaly judgment rules included in the relevant anomaly information (a series of configuration changes).

Next, the configuration change extraction program 36 generates a configuration change history of the anomaly corresponding to the relevant anomaly information on the basis of the information of these extracted logs and the anomaly information reported by the anomaly detection program 32 in step S31 and stores the generated configuration change history in the configuration change history management table 26 (S32). Furthermore, the configuration change extraction program 36 notifies the anomaly handling rule generation program 37 of an update of the configuration change history management table 26 together with the anomaly information received in step S31 (S33).

After receiving the above-mentioned notice, the anomaly handling rule generation program 37 acquires the configuration information of the management target apparatus 5, at which the anomaly included in the anomaly information occurred, from the apparatus configuration management table 22(FIG. 5) (S34).

Moreover, the anomaly handling rule generation program 37 extracts, on the basis of the configuration information acquired in step S34, the relevance between the anomaly component, which is stored in the anomaly component column 26 of a record of the configuration change history stored in the configuration change history management table 26 in step S32, and the change source target and the change destination target which are stored in the operation target column 261 (S35). Incidentally, the “relevance” herein used includes information about a connection relationship between the anomaly component and the change source target or the change destination target (for example, a connection relationship between a volume and a port), a parent-child relationship (for example, a parent-child relationship between a pool and a volume), a relevance (for example, a relevance between a pool and a parity group), and whether the change destination target is a new resource or not.

Subsequently, the anomaly handling rule generation program 37 stores each information of the apparatus model, the anomaly judgment rule, the anomaly component, the management apparatus ID, and the operation type, out of the configuration change history recorded in the configuration change history management table 26 in step S32, respectively in the apparatus model column 27B, the anomaly judgment rule column 27C, the anomaly component column 27D, the management apparatus type column 27E, and the operation type column 27F of the anomaly handling rule management table 27 (FIG. 10) and also stores the relevance between the anomaly component and the change source target, which was acquired in step S35, in the change source target column 27GA, and further stores the relevance between the anomaly component and the change destination target in the change destination target column 27GB (S36). Consequently, the anomaly handling rule corresponding to the configuration change history recorded in the configuration change history management table 26 in step S32 is stored in the anomaly handling rule management table 27, and then this anomaly handling rule generation processing terminates.

### 1-5) Anomaly Handling Processing

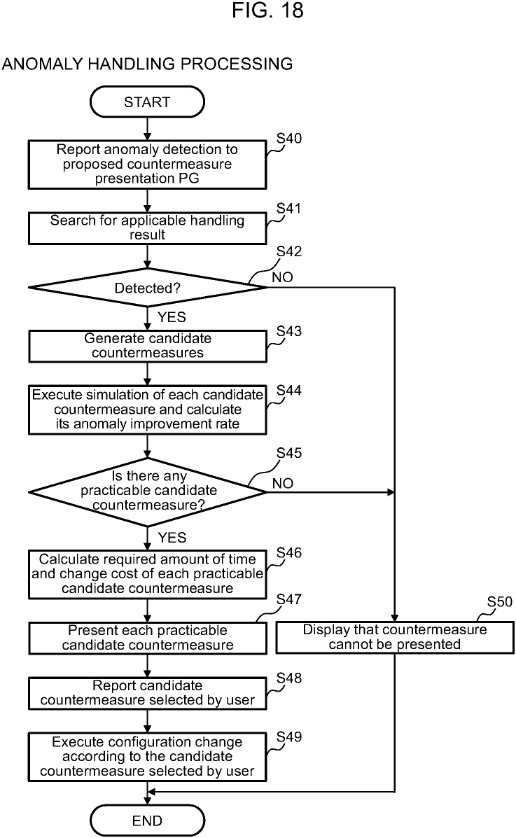

FIG. 18 illustrates specific processing content of the anomaly handling processing executed in step S6 of the anomaly handling and anomaly handling rule generation processing described earlier with reference to FIG. 14. This anomaly handling processing is started when the processing proceeds to step S6 of the anomaly handling and anomaly handling rule generation processing; and the anomaly detection program 32 firstly notifies the proposed countermeasure presentation program 33 (FIG. 2) of all the anomalies detected by the anomaly detection processing in step S2 of the anomaly handling and anomaly handling rule generation processing (S40).

Subsequently, the proposed countermeasure presentation program 33 searches the anomaly handling rule management table 27 (FIG. 11) for an anomaly handling rule(s) which is/are applicable as a proposed countermeasure(s) against the relevant anomaly with respect to each anomaly reported from the anomaly detection program 32 (S41). Incidentally, the “anomaly handling rule(s) which is/are applicable” herein used means an anomaly handling rule which matches the apparatus model of the management target apparatus 5 where the relevant anomaly was detected, and which further matches the anomaly component and the anomaly judgment rule used to extract the anomaly at that anomaly component.

Next, the proposed countermeasure presentation program 33 judges whether or not any anomaly handling rule(s) which is/are applicable was successfully detected by the search in step S41 (S42). Then, if the proposed countermeasure presentation program 33 obtains a negative result in this judgment, it displays a message stating that “the anomaly was detected, but any candidate proposed countermeasure against the anomaly cannot be presented,” on the display device 15 (FIG. 2) (S50), and then terminates this anomaly handling processing.

On the other hand, if the proposed countermeasure presentation program 33 obtains an affirmative result in the judgment of step S42, it refers to the apparatus configuration management table 22 (FIG. 4) and generates each candidate proposed countermeasure by selecting a change source target and a change destination target which become operation targets when applying each anomaly handling rule detected in step S41 to the latest anomaly (S43).

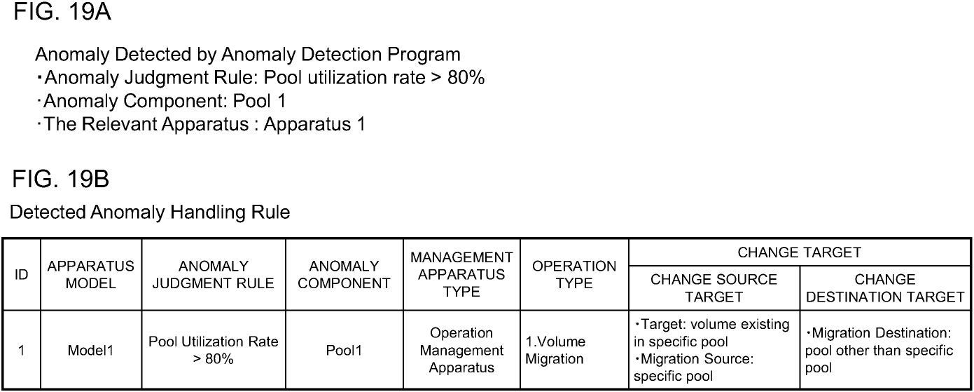

For example, let us assume that, as illustrated in FIG. 19A, the content of the anomaly reported from the anomaly detection program 32 to the proposed countermeasure presentation program 33 in step S40 satisfies the anomaly judgment rule specifying, “Pool Utilization Rate > 80%,” the anomaly component is “Pool 1,” and the relevant apparatus (the management target apparatus 5 at which the anomaly was detected) is “Apparatus 1”; and the anomaly handling rule detected from the anomaly handling rule management table 27 by the proposed countermeasure presentation program 33 in step S41 is an anomaly handling rule to which the anomaly handling the rule ID “1” is assigned in the anomaly handling rule management table 27 as illustrated in FIG. 19B.

In this case, the proposed countermeasure presentation program 33 searches for resources for the applicable “Change Source Target” on the basis of the change source target and the change destination target, which are stored in the change target column 28G of the anomaly handling rule management table 27 in FIG. 19B, and a resource configuration of the relevant management target apparatus 5 (“Apparatus 1” in this example) stored in the apparatus configuration management table 22 (FIG. 5). In the examples in FIG. 19B and FIG. 5, “Volume 1,” “Volume 2,” and “Volume 3” which are associated with “Pool 1” are detected by this search. Furthermore, the proposed countermeasure presentation program 33 also searches for resources for the applicable “Change Destination Target.” It is assumed here that “Pool 2” and “Pool 3” are detected by this search.

Then, if the proposed countermeasure presentation program 33 detects a plurality of resources for the applicable the “Change Source Target” by the above-described search, it selects the “Change Source Target” according to the selection criterion/criteria stored in the selection criteria column 28F (FIG. 11) of the configuration change operation management table 28 (FIG. 11) which was defined in advance. For example, if the selection criterion for the target volume regarding the change type of the “Volume Migration” is “volume capacity is large” as illustrated in FIG. 11, and if the capacity of “Volume 1” is “10 GB,” the capacity of “Volume 2” is “20 GB,” and the capacity of “Volume 3” is “30 GB” in the management target apparatus 5 which is “Apparatus 1” as illustrated in FIG. 5, “Volume 3” which has the largest capacity is selected as the “Change Source Target.”

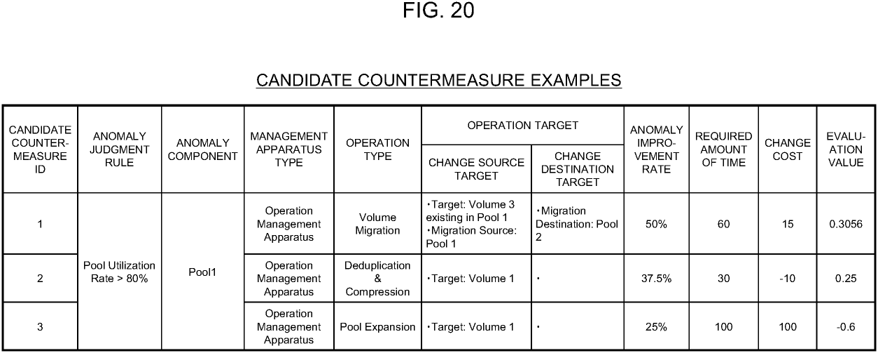

Moreover, if the proposed countermeasure presentation program 33 detects a plurality of resources for the applicable “Change Destination Target” by the aforementioned search, it selects the “Change Source Target” according to the selection criterion/criteria in the configuration change operation management table 28 which was defined in advance. For example, if the selection criterion for the migration destination regarding the change type of the “Volume Migration” is “the pool utilization rate is low” as illustrated in FIG. 11, and assuming that the pool utilization rate of “Pool 2” of “Apparatus 1” is “10%” and the pool capacity of “Pool 3” is “30%,” “Pool 2” which has the lowest pool utilization rate is selected as the “Change Destination Target.” Therefore, in this case, a candidate proposed countermeasure to which the candidate proposed countermeasure ID “1” is assigned in FIG. 20 (the operation type is “Volume Migration”; the migration source for the change source target is “Pool 1”; the target is “Volume 3 existing in Pool 1”; and the migration destination is “Pool 2”) is generated.

Incidentally, FIG. 20 illustrates an example where regarding an anomaly detected at the same anomaly component according to the anomaly judgment rule of the same apparatus model with respect to the management target apparatus 5 of the same apparatus mode, there are an anomaly handling rule which solved the anomaly by performing data deduplication and compression (“Deduplication & Compression”), and an anomaly handling rule which solved the anomaly by expanding the pool capacity (“Pool Expansion”); and based on these anomaly handling rules, a candidate proposed countermeasure with the candidate proposed countermeasure ID “2” and a candidate proposed countermeasure with the candidate proposed countermeasure ID “3” are generated.

Referring back to the explanation of FIG. 18, after generating all the candidate proposed countermeasures in step S43, the proposed countermeasure presentation program 33 executes a simulation of a case of a configuration change according to each of the generated candidate proposed countermeasures and calculates an anomaly improvement rate when performing each configuration change (S44).

Incidentally, the term “anomaly improvement rate” herein means an improvement rate of the status of the resource which is the target for the anomaly judgment rule satisfied by the latest anomaly and which is calculated according to the following expression.

$$\begin{matrix}\text{Anomaly Improvement Rate=} \\ \text{Value upon Occurrence of Anomaly} - \text{Simulation Result} \\ \text{Value upon Occurrence of Anomaly}\end{matrix} \qquad \text{[Math. 4]}$$

For example, when the latest anomaly was detected because the anomaly satisfies the anomaly judgment rule specifying the “Pool Utilization Rate > 80%” and the pool utilization rate when detecting the anomaly is 82% and the simulation result of the pool utilization rate when performing the configuration change of the candidate proposed countermeasure is 41%, the anomaly improvement rate is calculated as 0.5 as indicated in the following expression.

$$\text{Anomaly Improvement Rate =} \left(\text{82-41}\right) / 82 = 0.5 \qquad \text{[Math. 5]}$$

Subsequently, the proposed countermeasure presentation program 33 judges whether any practicable candidate proposed countermeasure is included in these candidate proposed countermeasures, on the basis of the anomaly improvement rate of each candidate proposed countermeasure as calculated in step S44 (S45). The judgment on whether it is “practicable” or not can be conducted based on the anomaly improvement rate; and, for example, if the simulation result of all the candidate proposed countermeasures is smaller than a threshold value, it is possible to determine that no practicable candidate proposed countermeasure is included.

Then, if the proposed countermeasure presentation program 33 obtains a negative result in the judgment of this step S 45 (that is, if there is no practicable candidate proposed countermeasure), it displays a message stating that “the anomaly was detected, but any candidate proposed countermeasure against the anomaly cannot be presented,” on the display device 15 (FIG. 2) (S50), and then terminates this anomaly handling processing.

On the other hand, if the proposed countermeasure presentation program 33 obtains an affirmative result in step S45, it calculates the required amount of time and the change cost, respectively, which are required to perform the configuration change of the relevant candidate proposed countermeasure, with respect to each candidate proposed countermeasure which is determined to be practicable (S46). Specifically speaking, the proposed countermeasure presentation program 33 calculates the required amount of time by referring to the required amount of time for the change, which is stored in the relevant required-amount-of-time-for-change column 28E (FIG. 11) of the configuration change operation management table 28 (FIG. 11) and calculates the change cost by referring to the change cost stored in the relevant change cost column 29C (FIG. 12) of the configuration change cost management table 29 (FIG. 12).

For example, if there are three types of candidate proposed countermeasures which are determined to be practicable in step S45 as indicated in FIG. 20 and the capacity of Volume 3 is 30 GB, the proposed countermeasure presentation program 33 calculates the required amount of time as 60 minutes according to the expression indicated below with respect to the candidate proposed countermeasure with the candidate proposed countermeasure ID “1” in FIG. 20, by using the required amount of time per unit capacity stored in the required-amount-of-time-for-change column 28E of a record whose change type stored in the configuration change type column 28C (FIG. 11) of the configuration change operation management table 28 is the “Volume Migration.”

$$\text{Required Amount of Time = 30} \times \text{2 = 60} \qquad \text{[Math. 6]}$$

Moreover, the proposed countermeasure presentation program 33 calculates the change cost of the above-described candidate proposed countermeasure as $15 according to the expression indicated below, for example, when the unit price of Pool 1 is $1/GB and the unit price of Pool 2 is $1.5/GB, by using the arithmetic expression (Difference of Bit Unit Price x Volume Capacity) which is stored in the change cost column 29C (FIG. 12) of the record whose configuration change type stored in the configuration change type column 29B (FIG. 12) of the configuration change cost management table 29 (FIG. 12) is the “Volume Migration.”

$$\text{Change Cost =} \left(1.5 \text{-1}\right) \times 30 = 15 \qquad \text{[Math. 7]}$$

Meanwhile, regarding the candidate proposed countermeasure with the candidate proposed countermeasure ID “2” in FIG. 20, the proposed countermeasure presentation program 33 calculates the required amount of time as 30 minutes according to the expression indicated below by assuming that data stored in Volume 1 is 30 GB (that is, a state of no empty space in Volume 1) and by using the required amount of time per unit data volume which is stored in the required-amount-of-time-for-change column 28E of a record with the operation ID “5” regarding which the configuration change type stored in the configuration change type column 28C (FIG. 11) of the configuration change operation management table 28 (FIG. 11) is “Compression & Deduplication.”

$$\text{Required Amount of Time = 30} \times \text{1 = 30} \qquad \text{[Math. 8]}$$

Moreover, the proposed countermeasure presentation program 33 calculates the change cost of the above-described candidate proposed countermeasure as $-10 according to the expression indicated below by using the arithmetic expression (Bit Unit Price x Data Reduced Capacity) stored in the change cost column 29C of the record regarding which the configuration change type stored in the configuration change type column 29B of the configuration change cost management table 29 is “Compression & Deduplication,” and assuming that a data reduced capacity of Volume 1 by the deduplication and compression processing is 10 GB.

$$\text{Change Cost = 1} \times \left(\text{-10}\right) = \text{-} 10 \qquad \text{[Math. 9]}$$

Furthermore, regarding the candidate proposed countermeasure with the candidate proposed countermeasure ID “3” in FIG. 20, the proposed countermeasure presentation program 33 calculates the required amount of time as 100 minutes according to the expression indicated below by assuming that Pool 1 is expanded for 100 GB, and using the required amount of time per unit added capacity stored in the required-amount-of-time-for-change column 28E of a record with the operation ID “6” regarding which the configuration change type stored in the configuration change type column 28C of the configuration change operation management table 28 is “Pool Expansion (Drive Addition).”

$$\text{Required Amount of Time = 100} \times \text{1 = 100} \qquad \text{[Math. 10]}$$

Moreover, the proposed countermeasure presentation program 33 calculates the change cost of the above-described candidate proposed countermeasure as $100 according to the expression indicated below by using the arithmetic expression (Bit Unit Price x Capacity To Be Added) stored in the change cost column 29C of a record regarding which the configuration change type stored in the configuration change type column 29B of the configuration change cost management table 29 is “Pool Expansion (Drive Addition).”

$$\text{Change Cost = 1} \times 100 = 100 \qquad \text{[Math. 11]}$$

Next, the proposed countermeasure presentation program 33 calculates an evaluation value of each of these candidate proposed countermeasures by using the anomaly improvement rate, the required amount of time, and the update cost of each candidate proposed countermeasure, which are calculated as described above, ranks these candidate proposed countermeasures based on the calculated evaluation value of each candidate proposed countermeasure, and displays a list of the anomaly improvement rate, the required amount of time, and the change cost of each candidate proposed countermeasure on the display device 15 (FIG. 2) (S47).

Specifically speaking, the proposed countermeasure presentation program 33 firstly obtains indexation values of the anomaly improvement rate, the required amount of time, and the change cost by using each evaluation function which is associated with the anomaly improvement rate, the required amount of time, and the change cost and stored in the proposed countermeasure evaluation function management table 30.

For example, regarding the anomaly improvement rate of the candidate proposed countermeasure with the candidate proposed countermeasure ID “1,” the proposed countermeasure presentation program 33 calculates an anomaly improvement rate indexation value which is an indexation value of the anomaly improvement rate by using the aforementioned Expression (1) and by substituting “50” for the “Anomaly Improvement Rate” of the relevant candidate proposed countermeasure, “25” which is the minimum value of the anomaly improvement rate among the three candidate proposed countermeasures for the “Minimum Value of Anomaly Improvement Rate,” and “50” which is the maximum value of the anomaly improvement rate among the three candidate proposed countermeasures for the “Maximum Value of Anomaly Improvement Rate,” respectively, as indicated in the expression indicated below.

$$\text{Anomaly Improvement Rate Indexation Value =} \left(50 \text{-} 25\right) / \left(\text{50-25}\right) = 1 \qquad \text{[Math. 12]}$$

Furthermore, the proposed countermeasure presentation program 33 also calculates the respective anomaly improvement rate indexation values of the candidate proposed countermeasure with the candidate proposed countermeasure ID “2” and the candidate proposed countermeasure with the candidate proposed countermeasure ID “3” in the same manner.

Moreover, regarding the required amount of time of the candidate proposed countermeasure with the candidate proposed countermeasure ID “1,” the proposed countermeasure presentation program 33 calculates a required amount-of-time indexation value which is an indexation value of the required amount of time by using the aforementioned Expression (2) and substituting “60” for the “Required Amount of Time” of the relevant candidate proposed countermeasure, “30” which is the minimum value of the required amount of time among the three candidate proposed countermeasures for the “Minimum Value of Required Amount of Time,” and “100” which is the maximum value of the required amount of time among the three candidate proposed countermeasures for the “Maximum Value of Required Amount of Time,” respectively, as indicated in the following expression.

$$\begin{matrix}\text{Required Amount-of-Time Indexation Value =} \\ \text{-1} \times \left(60 \text{-30}\right) / \left(100 \text{-30}\right) = \text{-} 0.428\end{matrix} \qquad \text{[Math. 13]}$$

Furthermore, the proposed countermeasure presentation program 33 also calculates the respective required amount-of-time indexation values of the candidate proposed countermeasure with the candidate proposed countermeasure ID “2” and the candidate proposed countermeasure with the candidate proposed countermeasure ID “3” in the same manner.

Furthermore, regarding the change cost of the candidate proposed countermeasure with the candidate proposed countermeasure ID “1,” the proposed countermeasure presentation program 33 calculates the change cost indexation value, which is an indexation value of the change cost, by using the aforementioned Expression (3) and substituting “15” for the “Change Cost” of the relevant candidate proposed countermeasure, “-10” which is the minimum value of the change cost among the three candidate proposed countermeasures for the “Minimum Value of Change Cost,” and “100” which is the maximum value of the change cost among the three candidate proposed countermeasures for the “Maximum Value of Change Cost,” respectively, as indicated in the following expression.

$$\text{Change Cost Indexation Value= -1} \times \left(15 \text{-} \left(\text{-10}\right)\right) / \left(100 \text{-} \left(\text{-10}\right)\right) \text{=-0} \text{.227} \qquad \text{[Math. 14]}$$

Furthermore, the proposed countermeasure presentation program 33 also calculates the respective change cost indexation values of the candidate proposed countermeasure with the candidate proposed countermeasure ID “2” and the candidate proposed countermeasure with the candidate proposed countermeasure ID “3” in the same manner.

Next, the proposed countermeasure presentation program 33: calculates the evaluation value of each candidate proposed countermeasure according to the expression indicated below by assuming that weights which are previously set to the anomaly improvement rate indexation value, the required amount-of-time indexation value, and the change cost indexation value are a1, a2, and a3, respectively; and ranks these candidate proposed countermeasures based on the calculated evaluation value of each candidate proposed countermeasure. Incidentally, it is assumed that the weights a1, a2, and a3 can be changed later.

$$\begin{matrix}\text{Evaluation Value =} \\ \text{a1} \times \text{Anomaly Improvement Rate Indexation Value +} \\ \text{a2} \times \text{Required Amount-of-Time Indexation Value +} \\ \text{a3} \times \text{Change Cost Indexation Value}\end{matrix} \qquad \text{[Math. 15]}$$

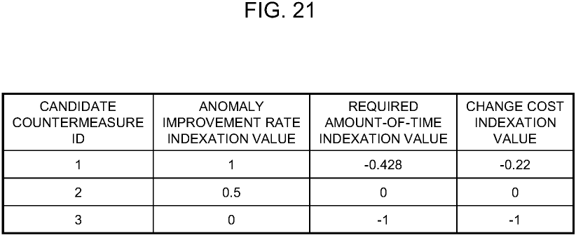

For example, assuming that a1, a2 and a3 are 0.5, 0.3, and 0.3, respectively, and the anomaly improvement rate indexation value, the required amount-of-time indexation value, and the change cost indexation value of each candidate proposed countermeasure are numerical values as respectively indicated in FIG. 21, the evaluation value of the candidate proposed countermeasure with the candidate proposed countermeasure ID “1” is 0.3056... as indicated in the following expression.

$$\text{Evaluation Value = 0} \text{.5} \times \text{1+0} \text{.3} \times \left(\text{-0} \text{.428}\right) \text{+0} \text{.3} \times \left(\text{-0} \text{.22}\right) \text{=0} \text{.3056} \qquad \text{[Math. 16]}$$

The evaluation value of the candidate proposed countermeasure with the candidate proposed countermeasure ID “2” is 0.25 as indicated in the following expression.

$$\text{Evaluation Value = 0} \text{.5} \times \text{0} \text{.5+0} \text{.3} \times \text{0+0} \text{.3} \times \text{0=0} \text{.25} \qquad \text{[Math. 17]}$$

The evaluation value of the candidate proposed countermeasure with the candidate proposed countermeasure ID “3” is -0.6 as indicated in the following expression.

$$\text{Evaluation Value = 0} \text{.5} \times \text{0+0} \text{.3} \times \left(\text{-1}\right) \text{+0} \text{.3} \times \left(\text{-} 1\right) \text{=-0} \text{.6} \qquad \text{[Math. 18]}$$

Therefore, in a case of this example, the candidate proposed countermeasures are ranked in the following order: the candidate proposed countermeasure with the candidate proposed countermeasure ID “1” is the highest rank; the candidate proposed countermeasure with the candidate proposed countermeasure ID “2” is the second highest rank; and the candidate proposed countermeasure with the candidate proposed countermeasure ID “3” is the lowest rank. Therefore, the proposed countermeasure presentation program 33 displays a list of the anomaly improvement rate, the required amount of time, and the change cost of the respective candidate proposed countermeasures which are ranked as described above, on the display device 15 (FIG. 2).

Subsequently, when the user selects one candidate proposed countermeasure as a countermeasure against the latest anomaly from among the candidate proposed countermeasures displayed as the list, the proposed countermeasure presentation program 33 sends a notice of that candidate proposed countermeasure (hereinafter referred to as the “user-selected candidate proposed countermeasure), together with an instruction to execute the configuration change processing, to the configuration change execution program 34 (S48). However, if the management target apparatus 5 which becomes the operation target for the candidate proposed countermeasure is managed by any one of intra-organization management apparatuses 6, the proposed countermeasure presentation program 33 sends the user-selected candidate proposed countermeasure and the instruction to execute the configuration change processing to that intra-organization management apparatus 6.

Incidentally, when the user selects a desired candidate proposed countermeasure and if that candidate proposed countermeasure is composed of two or more operations, it may be designed so that the user can select whether to execute all these operations or to execute only part of the operations. By doing so, if the logs extracted by the configuration change extraction program 36 in step S31 in FIG. 17 include any unnecessary log(s), it is possible to prevent the execution of an unnecessary operation(s) which may possibly be executed based on that log.

Then, the configuration change execution program 34 or the intra-organization management apparatus 6 which has received the user-selected candidate proposed countermeasure and the instruction to execute the configuration change processing executes the configuration change in accordance with the user-selected candidate proposed countermeasure reported from the proposed countermeasure presentation program 33 (S49). Consequently, this anomaly handling processing terminates.

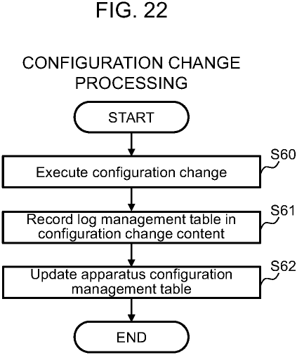

Incidentally, FIG. 22 illustrates a flow of processing of the configuration change execution program 34 or the intra-organization management apparatus 6 which has received the user-selected candidate proposed countermeasure and the instruction to execute the configuration change processing in step S48 of the aforementioned anomaly handling processing (hereinafter referred to as the “configuration change processing”).

When the instruction to execute the configuration change processing and the user-selected candidate proposed countermeasure are given from the proposed countermeasure presentation program 33, the configuration change execution program 34 or the intra-organization management apparatus 6 starts the configuration change processing illustrated in this FIG. 22 and firstly executes the configuration change processing in accordance with the user-selected candidate proposed countermeasure reported from the proposed countermeasure presentation program 33 (S60).

Subsequently, the configuration change execution program 34 generates a log indicating the content of the executed configuration change processing and records the generated log in the log management table 24 (FIG. 7) (S61). Furthermore, the configuration change execution program 34 updates the apparatus configuration management table 22 (FIG. 5) according to the configuration after the configuration change of the relevant management target apparatus 5 (S62), and then terminates this configuration change processing.

### Advantageous Effects of This Embodiment

With the computer system 1 according to this embodiment as described above, logs of a series of configuration changes performed with respect to the relevant management target apparatus 5 during a period of time after an anomaly of that management target apparatus 5 was detected until the anomaly was solved are extracted from the log management table 24; the extracted logs are recorded as a configuration change history in the configuration change history management table 26; anomaly handling rules are generated by generalizing the content of the recorded configuration change history; and if a new anomaly is detected, one or a plurality of candidate proposed countermeasures are generated by using the anomaly handling rules, which are applicable, and the generated candidate proposed countermeasure(s) is/are presented to the user.

Therefore, according to this embodiment, the proposed countermeasure(s) against the latest anomaly can be generated and presented based on a series of configuration changes which were performed upon the occurrence of anomalies in the past and by which were solved then, so that it is possible to realize the highly reliable operation management apparatus 4 capable of presenting the highly effective countermeasures.

### Other Embodiments

Incidentally, the aforementioned embodiment has described the case where the proposed countermeasure presentation and execution function upon anomaly according to this embodiment is mounted in one computer device (the operation management apparatus 4); however, the present invention is not limited to this example and a part or whole of the proposed countermeasure presentation and execution function upon anomaly may be distributed and mounted in a plurality of computer devices which constitute a distributed computing system.

Moreover, the aforementioned embodiment has described the case where the management target apparatus(es) 5 is/are the storage apparatus(es) 5A or the like; however, the present invention is not limited to this example and the present invention can be widely applied even when the management target apparatus(es) 5 is/are other kinds of apparatuses.

Furthermore, the aforementioned embodiment has described the case where there is provided the log collection program 35 for collecting the log information about the configuration changes of each management target apparatus 5, which belongs to the organization 2 provided with the intra-organization management apparatus 6, from the intra-organization management apparatus 6; however, the present invention is not limited to this example and each intra-organization management apparatus 6 may be designed to regularly transmit the log information, which each intra-organization management apparatus 6 retains, to the operation management apparatus 4. Even by doing so, the proposed countermeasures including the configuration change operation(s) which cannot be executed by only the operation management apparatus 4 can be generated and presented to the user in the same manner as in the case of the embodiment.

Furthermore, the aforementioned embodiment has described the case where the proposed countermeasure presentation program 33 calculates the anomaly improvement rate, the required amount of time, and the update cost of each candidate proposed countermeasure, ranks the candidate proposed countermeasures on the basis of the anomaly improvement rate, the required amount of time and the update cost which are calculated, and presents the ranked candidate proposed countermeasures to the user; however, the present invention is not limited to this example and the candidate proposed countermeasures may be ranked on the basis of at least one of the anomaly improvement rate, the required amount of time, and the update cost.

### INDUSTRIAL AVAILABILITY

The present invention can be applied to a wide variety of operation management apparatuses which manage the operation of the entire computer system including one or a plurality of management target apparatuses.

REFERENCE SIGNS LIST

| | |
|---|---|
| 1: | computer system |
| 2: | organization |
| 4: | operation management apparatus |
| 5: | management target apparatus |
| 6: | intra-organization management apparatus |
| 10: | CPU |
| 20: | management target management table |
| 21: | intra-organization management apparatus management table |
| 22: | apparatus configuration management table |
| 23: | operating information management table |
| 24: | log management table |
| 25: | anomaly judgment rule management table |
| 26: | configuration change history management table |
| 27: | anomaly handling rule management table |
| 28: | configuration change operation management table |
| 29: | configuration change cost management table |
| 30: | proposed countermeasure evaluation function management table |
| 31: | apparatus information collection program |
| 32: | anomaly detection program |
| 33: | proposed countermeasure proposing program |
| 34: | configuration change execution program |
| 35: | log collection program |
| 36: | configuration change extraction program |
| 37: | anomaly handling rule generation program |

1. An operation management apparatus for managing operation of an entire system including one or a plurality of management target apparatuses,
the operation management apparatus comprising:
an anomaly detection unit that detects an anomaly of the management target apparatus;
a configuration change extraction unit that extracts, from logs, content of a series of configuration changes performed with respect to the management target apparatus during a period of time after the anomaly detection unit detected the anomaly of the management target apparatus until the anomaly was solved, and records the extracted content of the series of configuration changes as a configuration change history;
an anomaly handling rule generation unit that generates anomaly handling rules by generalizing the content of the configuration change history recorded by the configuration change extraction unit; and
a proposed countermeasure presentation unit that, when the anomaly detection unit detects a new anomaly, generates one or a plurality of proposed countermeasures by using the anomaly handling rules, which are applicable, and presents the generated proposed countermeasure to a user.

2. The operation management apparatus according to claim 1,
further comprising a log collection unit that collects logs of configuration changes performed with respect to some of the management target apparatuses from a management apparatus for managing some of the management target apparatuses, wherein the configuration change extraction unit extracts content of a series of configuration changes performed with respect to the management target apparatus during a period of time after an anomaly of the management target apparatus managed by the management apparatus was detected until the anomaly was solved, in order to solve the anomaly from all the logs including the logs collected by the log collection unit and records the extracted content of the series of configuration changes as the configuration change history.

3. The operation management apparatus according to claim 1,
wherein the configuration change extraction unit extracts all logs from a time of day when the anomaly was detected until a time of day when the anomaly was solved, as logs with content of a series of configuration changes performed with respect to the management target apparatus during a period of time after the anomaly detection unit detected the anomaly of the management target apparatus until the anomaly was solved.

4. The operation management apparatus according to claim 1,
wherein the anomaly detection unit detects an anomaly or anomalies which have occurred in the management target apparatus, by comparing a plurality of anomaly judgment rules, which are previously determined in order to judge whether the management target apparatus is anomalous or not, with an operating status of each of the management target apparatuses; and
wherein the configuration change extraction unit: manages countermeasures, each of which is normally executed against each of the anomalies detected by the anomaly judgment rules, with respect to each of the anomaly judgment rules; and
extracts the content of the series of configuration changes by deciding a search range with an occurrence date and time of the anomaly based on a date and time when the anomaly occurred, and extracting all the configuration changes which are recorded as the logs within the decided search range and match countermeasures associated with the anomaly judgment rules used when detecting the anomaly.

5. The operation management apparatus according to claim 1,
wherein the anomaly detection unit detects an anomaly or anomalies which have occurred in the management target apparatus, by comparing a plurality of anomaly judgment rules, which are previously determined in order to judge whether the management target apparatus is anomalous or not, with an operating status of each of the management target apparatuses; and
wherein the anomaly handling rule generation unit extracts a relevance between an anomaly component where the anomaly occurred, and a change source and a change destination of the configuration change performed with respect to the anomaly and generates the anomaly handling rule on the basis of the extracted relevance, the anomaly component, an apparatus model of the management target apparatus, at which the anomaly has occurred, and the anomaly judgment rule used when detecting the anomaly.

6. The operation management apparatus according to claim 1,
wherein the proposed countermeasure presentation unit: calculates at least one of an anomaly improvement rate, a required amount of time, and a change cost when executing a countermeasure which is each of the generated proposed countermeasures; and ranks each of the proposed countermeasures on the basis of the anomaly improvement rate, the required amount of time, and/or the change cost which are calculated, and presents the ranked proposed countermeasures to the user.

7. An operation management method executed by an operation management apparatus for managing operation of an entire system including one or a plurality of management target apparatuses,
the operation management method comprising:
a first step of extracting, from logs, content of a series of configuration changes performed with respect to the management target apparatus during a period of time after the anomaly of the management target apparatus was detected until the anomaly was solved, and recording the extracted content of the series of configuration changes as a configuration change history;
a second step of generating anomaly handling rules by generalizing the content of the recorded configuration change history; and
a third step, which is executed when detecting an anomaly, of generating one or a plurality of proposed countermeasures by using the anomaly handling rules, which are applicable, and presenting the generated proposed countermeasure to a user.

8. The operation management method according to claim 7,
wherein the operation management apparatus collects logs of configuration changes performed with respect to some of the management target apparatuses from a management apparatus for managing some of the management target apparatuses; and wherein in the first step,
content of a series of configuration changes performed with respect to the management target apparatus during a period of time after an anomaly of the management target apparatus managed by the management apparatus was detected until the anomaly was solved, in order to solve the anomaly is extracted from all the logs including the logs collected by the log collection unit and the extracted content of the series of configuration changes is recorded as the configuration change history.

9. The operation management method according to claim 7,
wherein in the first step, the operation management apparatus extracts all logs from a time of day when the anomaly was detected until a time of day when the anomaly was solved, as logs with content of a series of configuration changes performed with respect to the management target apparatus during a period of time after the anomaly detection unit detected the anomaly of the management target apparatus until the anomaly was solved.

10. The operation management method according to claim 7,
wherein the operation management apparatus detects an anomaly or anomalies which have occurred in the management target apparatus, by comparing a plurality of anomaly judgment rules, which are previously determined in order to judge whether the management target apparatus is anomalous or not, with an operating status of each of the management target apparatuses; and
wherein in the first step, the operation management apparatus:
manages countermeasures, each of which is normally executed against each of the anomalies detected by the anomaly judgment rules, with respect to each of the anomaly judgment rules; and
extracts the content of the series of configuration changes by deciding a search range with an occurrence date and time of the anomaly based on a date and time when the anomaly occurred, and extracting all the configuration changes which are recorded as the logs within the decided search range and match countermeasures associated with the anomaly judgment rules used when detecting the anomaly.

11. The operation management method according to claim 7,
wherein the operation management apparatus detects an anomaly or anomalies which have occurred in the management target apparatus, by comparing a plurality of anomaly judgment rules, which are previously determined in order to judge whether the management target apparatus is anomalous or not, with an operating status of each of the management target apparatuses; and
wherein in the second step, the operation management apparatus extracts a relevance between an anomaly component where the anomaly occurred, and a change source and a change destination of the configuration change performed with respect to the anomaly and generates the anomaly handling rule on the basis of the extracted relevance, the anomaly component, an apparatus model of the management target apparatus, at which the anomaly has occurred, and the anomaly judgment rule used when detecting the anomaly.

12. The operation management method according to claim 7,
wherein in the third step, the operation management apparatus: calculates at least one of an anomaly improvement rate, a required amount of time, and a change cost when executing a countermeasure which is each of the generated proposed countermeasures; and ranks each of the proposed countermeasures on the basis of the anomaly improvement rate, the required amount of time, and/or the change cost which are calculated, and presents the ranked proposed countermeasures to the user.
